(19) United States
(12) Patent Application Publication
(10) Pub. No.: US 2024/0416283 A1
(43) Pub. Date: Dec. 19, 2024

(54) APPARATUS AND METHOD OF SEMI-CLOSED REVERSE OSMOSIS

(71) Applicant: Nanyang Technological University, Singapore (SG)

(72) Inventors: Qianhong SHE, Singapore (SG); Zijing MO, Singapore (SG)

(73) Assignee: Nanyang Technological University, Singapore (SG)

(21) Appl. No.: 18/702,217

(22) PCT Filed: Oct. 19, 2022
(86) PCT No.: PCT/SG2022/050743

§ 371 Date: Apr. 17, 2024

(30) Foreign Application Priority Data
Oct. 19, 2021 (SG) 10202111588T

(51) Int. Cl. B01D 61/02; B01D 61/06; B01D 61/08; B01D 61/12

(52) U.S. Cl. CPC B01D 61/025; B01D 61/06; B01D 61/08; B01D 61/12; B01D 2313/246; B01D 2313/502; B01D 2317/025

(57) ABSTRACT

A system comprising: a reverse osmosis (RO) membrane module having an inlet, a permeate outlet, and a concentrate outlet, the RO membrane module being operable to separate a feed into a RO permeate and a RO concentrate, the RO concentrate being delivered out of the RO membrane module via the concentrate outlet; a first tank; and a fluid circuit, the fluid circuit coupling the RO membrane module and the first tank, the fluid circuit being configured to provide a flow path including: a first feed flow path directing the feed to the inlet; a first concentrate flow path directing the RO concentrate from the concentrate outlet to the first tank; and a second feed flow path directing the feed from the first tank to the inlet, wherein the first feed flow path and the second feed flow path are configured to receive the feed from different sources.

The present application claims priority to the Singapore patent application Ser. No. 10/202,111588T, the entire disclosure of which is incorporated herein by reference.

### TECHNICAL FIELD

The present disclosure relates to the treatment of liquids, and more particularly to a system and method of reverse osmosis.

### BACKGROUND

In conventional single-stage reverse osmosis, a constant hydraulic pressure is applied along the membrane module. The hydraulic pressure needs to be higher than the osmotic pressure of the final exiting stream. The osmotic pressure of the exiting stream becomes increasingly significant for higher recovery, and the difference between osmotic pressures at the inlet and at the outlet of the membrane module becomes increasingly greater. Therefore, in practice, the amount of energy loss from operating a conventional single-stage reverse osmosis system limits its use such that conventional single-stage reverse osmosis is not a practical choice for high energy efficiency and high recovery.

### SUMMARY

In one aspect, the present application discloses a system, comprising: a reverse osmosis (RO) membrane module having an inlet, a permeate outlet, and a concentrate outlet, the RO membrane module being operable to separate a feed into a RO permeate and a RO concentrate, the RO concentrate being delivered out of the RO membrane module via the concentrate outlet; a first tank; and a fluid circuit, the fluid circuit coupling the RO membrane module and the first tank, the fluid circuit being configured to provide a flow path including: a first feed flow path directing the feed to the inlet; a first concentrate flow path directing the RO concentrate from the concentrate outlet to the first tank; and a second feed flow path directing the feed from the first tank to the inlet, wherein the first feed flow path and the second feed flow path are configured to receive the feed from different sources.

The system may further comprise: a second tank, the second tank being coupled to the fluid circuit, wherein the fluid circuit is configured to alternate between providing the first feed flow path in a first cycle and providing the second feed flow path in a second cycle, the first cycle and the second cycle being successive cycles of at least two cycles of liquid through the RO membrane module, wherein: in the first cycle, the feed is received from the second tank and directed along the first feed flow path to the RO membrane module, the second tank serving as a feed tank in the first cycle; and in the first cycle, the RO concentrate is directed along the first concentrate flow path from the RO membrane module to the first tank, the first tank serving as a receiver tank in the first cycle, and wherein: in the second cycle, the feed is received from the first tank and directed along the second feed flow path to the RO membrane module, the first tank serving as the feed tank in the second cycle; and in the second cycle, the RO concentrate is directed along a second concentrate flow path from the RO membrane module to the second tank, the second tank serving as the receiver tank.

In the first cycle, the first feed flow path and the first concentrate flow path do not converge upstream of the inlet and downstream of the second tank, and wherein in the second cycle, the second feed flow path and the second concentrate flow path do not converge upstream of the inlet and downstream of the first tank. The RO concentrate of a current cycle is prevented from mixing with the feed of the current cycle, the current cycle being any one of the at least two cycles.

Each of the first tank and the second tank may be configured to alternately serve as the feed tank to provide the feed in the current cycle and as the receiver tank to receive the RO concentrate in a subsequent cycle, the subsequent cycle immediately following the current cycle.

The fluid circuit is configured to prevent a direct flow path of liquid from the receiver tank to the feed tank within each of the at least two cycles, in which the direct flow path does not pass through the RO membrane module.

The RO concentrate out of the RO membrane module may be characterized by an osmotic pressure for each of the at least two cycles, and wherein the feed of each cycle is delivered to the inlet at a target pressure, the target pressure being controllably variable between any of the at least two cycles such that the target pressure is at least minimally greater than the osmotic pressure of the RO concentrate out of the RO membrane module in the current cycle.

The system may further comprise: a pump coupled to the fluid circuit, the pump being configured to deliver the feed to the inlet at a target pressure, wherein the pump is configured to progressively increase the target pressure with each of the successive cycles. The pump may be configured to alternate between (i) receiving the feed from the second tank in the first cycle and (ii) receiving the feed from the first tank in the second cycle.

The system may further comprise: an energy recovery device coupled to the fluid circuit, the energy recovery device being configured to recover energy from the RO concentrate, wherein the energy recovery device is configured to at least partially pressurize the feed.

The fluid circuit further may comprise a fresh feed inlet configured to receive one intake of fresh feed, and wherein the one intake of fresh feed is cycled through the RO membrane module for the at least two cycles.

The system may be configured to initiate a discharge of remaining liquid in the fluid circuit and in any of the first tank and the second tank, and wherein the discharge is initiated in response to a recovery parameter reaching a threshold value. The recovery parameter may be determined based on a condition of the RO permeate at the permeate outlet, a condition of the feed, a condition of the RO concentrate out of the RO membrane module, a specific energy consumption, a number of cycles, a permeate flowrate, or any combination thereof.

The system may further comprise a treatment unit, the treatment unit being configured to provide at least one chemical dosage to respective contents of one or both of the feed tank and the receiver tank. The treatment unit may comprise one or more third tank configured to receive the RO concentrate from the RO membrane module and to deliver a treated concentrate to the receiver tank, wherein the treatment unit is configured to provide the at least one chemical dosage to the one or more third tank and to provide for at least partial settlement of non-dissolvable particles in the one or more third tank before the treated concentrate is delivered to the receiver tank. The system may further comprise a filtration unit coupled to the fluid circuit, the filtration unit being configured to filter the feed received from the feed tank. The system may further comprise a secondary membrane module coupled to the fluid circuit, wherein the secondary membrane module is operable to separate the RO concentrate from the RO membrane module into a secondary permeate and a secondary retentate, the secondary permeate being received by the receiver tank. The secondary membrane module may be one or more of a low salt-rejection RO (LSRRO) membrane module, a nanofiltration (NF) membrane module, an ultrafiltration (UF) membrane module, a microfiltration (MF) membrane module, or any combination thereof. The fluid circuit may be configured to recover energy from the secondary retentate before discharging the secondary retentate. The RO membrane module may comprise one or more RO membranes, and wherein at least one of the one or more RO membranes is characterized by a rejection rate of 80% sodium chloride rejection rate or above 80% sodium chloride rejection rate.

In another aspect, a method of the present disclosure comprises: directing a feed along a first feed flow path in a fluid circuit, the fluid circuit being configured to provide a flow path in a system including a first tank and a reverse osmosis (RO) membrane module, the RO membrane module having an inlet, a permeate outlet, and a concentrate outlet, the RO membrane module being operable to separate the feed into a RO permeate and a RO concentrate; directing the RO concentrate along a first concentrate flow path from the concentrate outlet to the first tank; and directing the feed along a second feed flow path from the first tank to the inlet, wherein the first feed flow path and the second feed flow path are configured to receive the feed from different sources, and wherein the flow path includes the first feed flow path, the first concentrate flow path, and the second feed flow path.

The method may comprise: alternating between providing the first feed flow path in a first cycle and providing the second feed flow path in a second cycle, the first cycle and the second cycle being successive cycles of at least two cycles of liquid through the RO membrane module, wherein the first cycle includes receiving the feed from a second tank and directing the feed along the first feed flow path to the RO membrane module, the second tank serving as a feed tank in the first cycle; and wherein the first cycle includes directing the RO concentrate along the first concentrate flow path from the RO membrane module to the first tank, the first tank serving as a receiver tank in the first cycle, and wherein the second cycle includes receiving the feed from the first tank and directing the feed along the second flow path from the first tank to the RO membrane module, the first tank serving as the feed tank in the second cycle; and wherein the second cycle includes directing the RO concentrate along a second concentrate flow path from the RO membrane module to the second tank, the second tank serving as the receiver tank.

The first cycle, the first feed flow path and the first concentrate flow path do not converge upstream of the inlet and downstream of the second tank, and in the second cycle, the second feed flow path and the second concentrate flow path do not converge upstream of the inlet and downstream of the first tank.

The method may further comprise: for one intake of fresh feed, performing all of the at least two cycles. The method may further comprise: controllably setting a target pressure at which the feed is delivered to the RO membrane module such that the target pressure is at least minimally greater than an osmotic pressure of the RO concentrate out of the RO membrane module in a current cycle. The method may further comprise: progressively increasing the target pressure over the successive cycles. The method may further comprise: chemically treating respective contents of one or both of the feed tank and the receiver tank. The method may further comprise: passing the RO concentrate through a secondary membrane module, wherein the secondary membrane module is configured to filter impurities out from the RO concentrate. The secondary membrane module may include one or more of a low-salt-rejection RO (LSRRO) membrane module, a nanofiltration (NF) membrane module, an ultrafiltration (UF) membrane module, a microfiltration (MF) membrane module, or any combination thereof.

### BRIEF DESCRIPTION OF DRAWINGS

FIG. 1 is a schematic diagram of a semi-closed reverse osmosis (SCRO) system with an energy recovery device (ERD) according to one embodiment of the present disclosure;

FIGS. 1A to 1F are schematic diagrams illustrating various cycles of a method of SCRO with ERD;

FIG. 2 is a schematic diagram of a SCRO system without ERD, according to another embodiment of the present disclosure;

FIGS. 2A to 2F are schematic diagrams illustrating various cycles of a method of SCRO without ERD;

FIGS. 3A and 3B are schematic diagrams illustrating different embodiments with chemical dosing;

FIGS. 4A and 4B are schematic diagrams illustrating different embodiments with an external treatment unit;

FIGS. 5A and 5B are schematic diagrams illustrating different embodiments with additional filtration;

FIG. 6A is a schematic diagram illustrating a cycle in a method of SCRO with ERD with an additional second stage purification;

FIG. 6B is a schematic diagram illustrating a final cycle in the system of FIG. 6A;

FIG. 7A is a schematic diagram illustrating a cycle in a method of SCRO without ERD with an additional second stage purification;

FIG. 7B is a schematic diagram illustrating a final cycle in the system of FIG. 7A;

FIG. 8 is a schematic illustration of an example of a reverse osmosis membrane module formed by an array of pressure vessels and the membrane elements in the pressure vessels, for use in the proposed system of FIG. 1 or FIG. 2;

FIG. 9 is a plot showing the thermodynamic minimum specific energy consumption (SEC) of various reverse osmosis (RO) processes as a function of recovery for seawater desalination;

FIG. 10A is a plot showing the minimal SEC for seawater desalination of various RO processes in comparison with SCRO with ERD, taking into consideration practical inefficiencies of pumps and energy recovery devices, as well as frictional energy loss, assuming 98% ERD efficiency, 80% pump efficiency, and 0.1 bar pressure loss per stage or cycle;

FIG. 10B is a plot showing the minimal SEC for seawater desalination of various RO processes in comparison with SCRO with ERD, taking into consideration practical inefficiencies of pumps and energy recovery devices, as well as frictional energy loss, assuming 98% ERD efficiency, 80% pump efficiency, and 0.2 bar pressure loss per stage or cycle;

FIG. 10C is a plot showing the minimal SEC for seawater desalination of various RO processes in comparison with SCRO with ERD, taking into consideration practical inefficiencies of pumps and energy recovery devices, as well as frictional energy loss, assuming 98% ERD efficiency, 80% pump efficiency, and 1 bar pressure loss per stage or cycle;

FIG. 11A is a plot showing the minimal SEC for seawater desalination of various RO processes in comparison with SCRO without ERD, taking into consideration practical inefficiencies of pumps, as well as frictional energy loss, assuming 80% pump efficiency, and 0.1 bar pressure loss per stage or cycle;

FIG. 11B is a plot showing the minimal SEC for seawater desalination of various RO processes in comparison with SCRO without ERD, taking into consideration practical inefficiencies of pumps, as well as frictional energy loss, assuming 80% pump efficiency, and 0.2 bar pressure loss per stage or cycle; and

FIG. 11C is a plot showing the minimal SEC for seawater desalination of various RO processes in comparison with SCRO without ERD, taking into consideration practical inefficiencies of pumps, as well as frictional energy loss, assuming 80% pump efficiency, and 1 bar pressure loss per stage or cycle.

### DETAILED DESCRIPTION

Reference throughout this specification to “one embodiment”, “another embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment. Furthermore, the described features, structures, or characteristics may be combined in any suitable manner in one or more embodiments. In the following description, numerous specific details are provided to give a thorough understanding of embodiments. One skilled in the relevant art will recognize, that the various embodiments may be practiced without one or more of the specific details, or with other methods, components, materials, etc. In other instances, some or all known structures, materials, or operations may not be shown or described in detail to avoid obfuscation.

The word “exemplary” is used herein to mean “serving as an example, instance, or illustration.” Any embodiment described herein as “exemplary” is not necessarily to be construed as preferred or advantageous over other embodiments. As used herein, the singular ‘a’ and ‘an’ may be construed as including the plural “one or more” unless apparent from the context to be otherwise.

Terms such as “first” and “second” are used in the description and claims only for the sake of brevity and clarity, and do not necessarily imply a priority or order, unless required by the context. The terms “about” and “approximately” as applied to a stated numeric value encompasses the exact value and a reasonable variance as will be understood by one of ordinary skill in the art, and the terms “generally” and “substantially” are to be understood in a similar manner, unless otherwise specified.

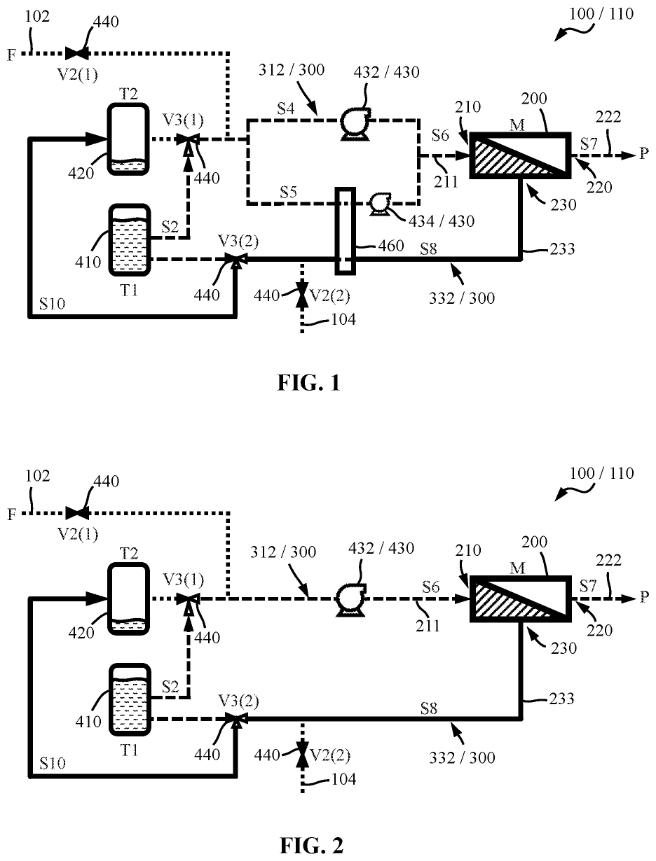

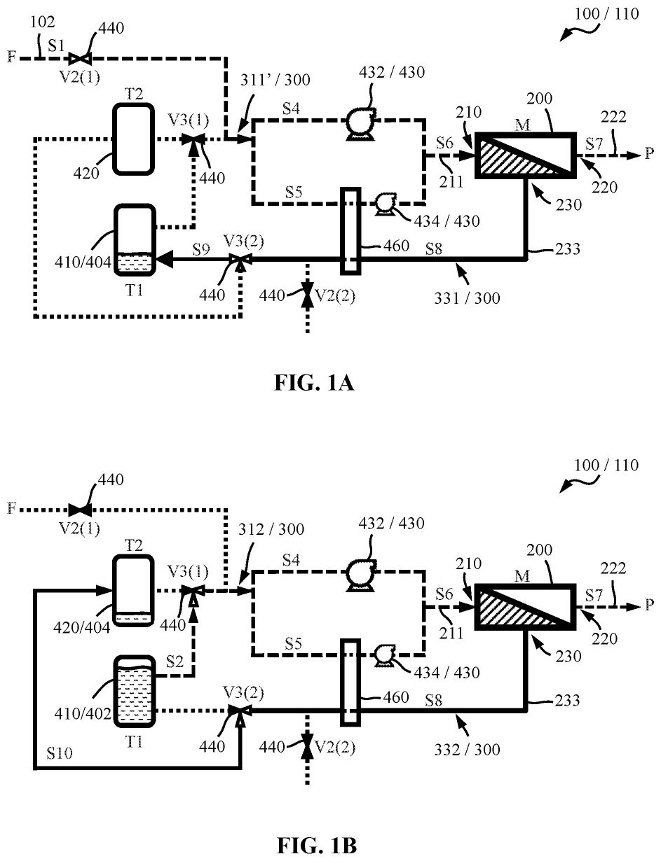

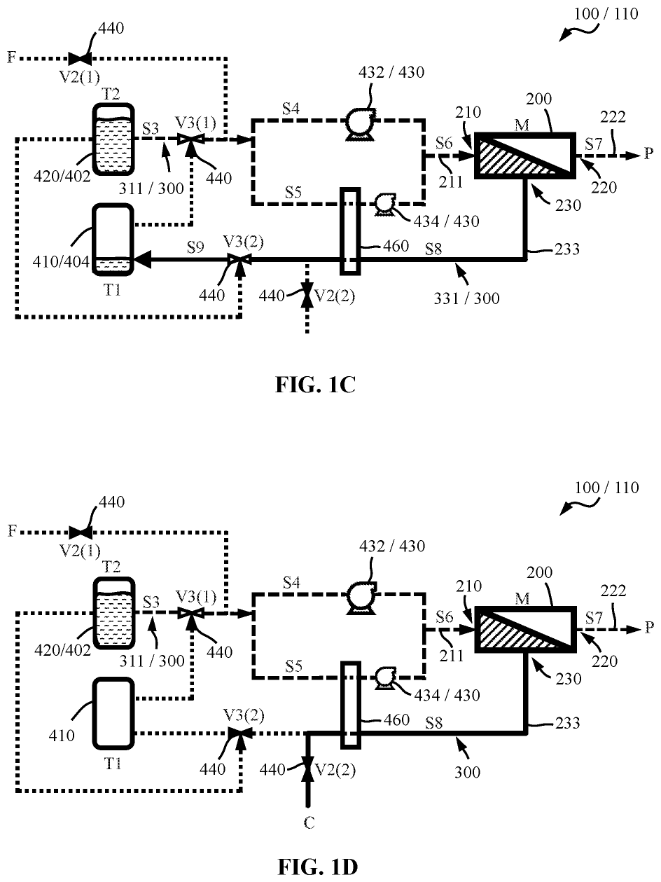

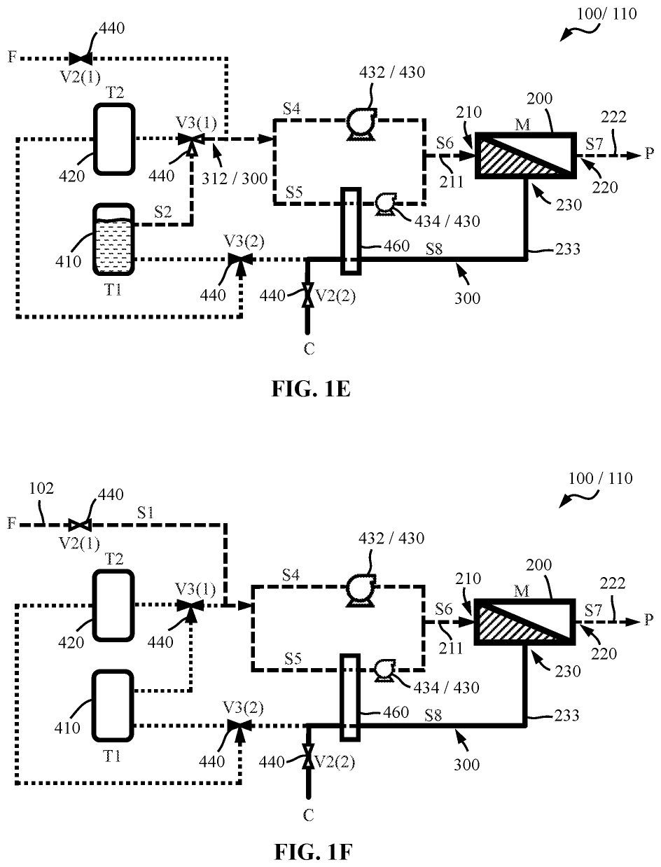

FIG. 1 is a schematic diagram of a system 100, the system 100 being configured for semi-closed reverse osmosis (SCRO) processes according to one embodiment of the present disclosure. The system 100 includes a reverse osmosis (RO) membrane module 200 and a first tank 410 (tank T1). The system 100 further includes a fluid circuit 110 coupling the RO membrane module 200 and the first tank 410. The RO membrane module 200 includes an inlet 210, a permeate outlet 220, and a concentrate outlet 230. The RO membrane module 200 includes at least one membrane disposed therein such that a liquid being cycled through the RO membrane module 200 will be separated by reverse osmosis taking place across the at least one membrane. Liquid fed to the RO membrane module 200 via the inlet 210 is referred to as a feed 211 (feed inflow). The feed 211 (stream S6) received via the inlet 210 into the RO membrane module 200 is cycled through the RO membrane module 200, such that the feed 211 is separated into a reverse osmosis (RO) permeate 222 (stream S7) and a RO concentrate 233. In the present disclosure, the term “RO concentrate” may also refer to a concentrate effluent or stream S8 out from the RO membrane module 200. The term “concentrate” may refer to the RO concentrate out from the RO membrane module 200 and/or a treated concentrate, the term “treated concentrate” as used herein referring to the concentrate stream/solution obtained from additional treatment of the RO concentrate. The RO permeate 222 is delivered out of the permeate outlet 220 and the RO concentrate 233 out of the RO membrane module 200 flows through concentrate outlet 230. The RO membrane module 200 of the present system 100 may be variously configured. For example, in some embodiments, the RO membrane module 200 may include one or more RO membranes in which at least one of the one or more RO membrane is any membrane characterized by a high rejection rate. A membrane with a high rejection rate refers to the membrane being capable of 80% sodium chloride rejection rate or more than 80% sodium chloride rejection rate. It will be understood that a rejection rate of 80% refers to a rejection rate of about 80%. In other words, as used herein, the term “RO membrane” is not intended to be limited to only those membranes traditionally selected for conventional reverse osmosis processes. In one aspect, advantageously, the variety of membranes that can be selected for use in the present system 100 can be expanded beyond the conventionally used membranes because of the higher efficiencies enabled by the present system 100.

An energy recovery device (ERD) 460 may be provided to recover some energy from the RO concentrate 233 (stream S8) and partially pressurizing a part of the feed (stream S5). Stream S5 may be further pressurized with the aid of a pump 430 (such as a booster pump 434 or a recirculation pump). Another part of the feed 211 (stream S4) may be pressurized by another pump 430, such as a high-pressure pump 432. Stream S4 and stream S5 may thus combine to provide stream S6 at a target pressure (hydraulic pressure) that is higher than the osmotic pressure difference between exiting streams (i.e., between S8 and S7) of the RO membrane module 200. Various energy recovery devices 460 may be selected for use, examples of which include but are not limited to pressure exchangers (PX), Pelton turbine (PT), dual work exchanger energy recover (SWEER) systems, etc.

The fluid circuit 110 may include a fresh feed inlet 102. The fluid circuit 110 may be embodied in the form of fluid delivery conduits or pipes, etc., at least one pump 430, and one of valves 440 such that the fluid circuit 110 may be controllably configured to direct a flow path 300 of liquid through at least part of the system 100. For example, a valve 440, e.g., a two-way valve V2(1), may be provided at the fresh feed inlet 102 to control the amount of fresh feed taken into the system 100 at each intake. Another valve 440, e.g., a three-way valve V3(2), may be provided to controllably permit the RO concentrate 233 to flow to only one of the first tank 410 (tank T1) and a second tank 420 (tank T2). A two-way valve V2(2) may be provided to controllably allow liquid to be discharged out of the system 100 via a discharge outlet 104. Another valve 440, e.g., a three-way valve V3(1) may be provided to controllably control whether to draw the feed 211 from the first tank 410 (tank T1) or to draw the feed 211 from the second tank 420 (T2).

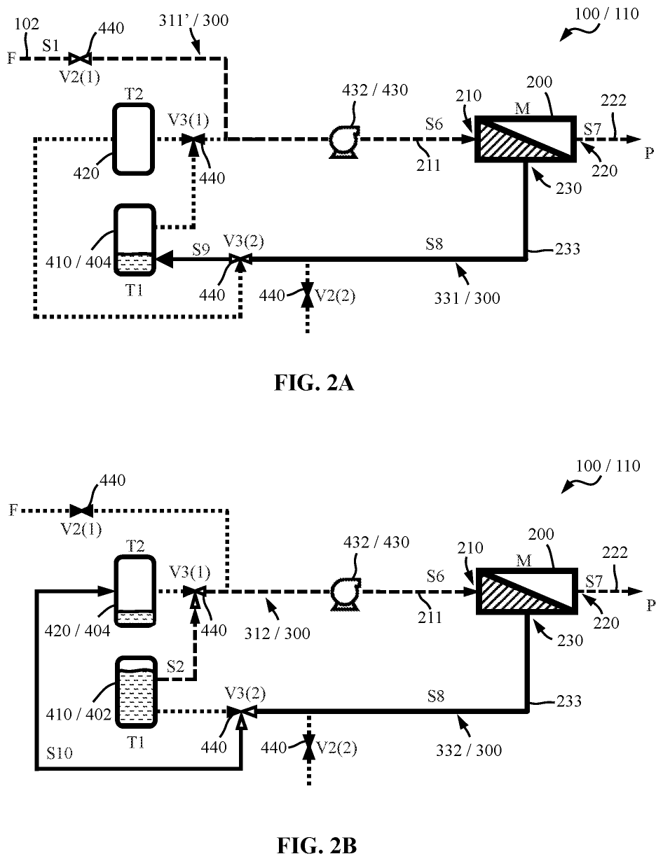

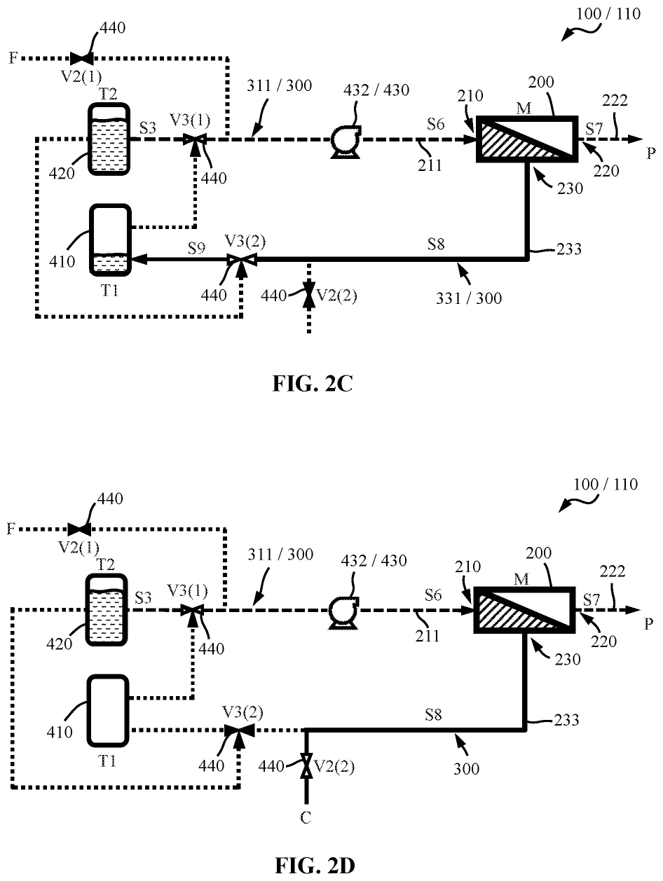

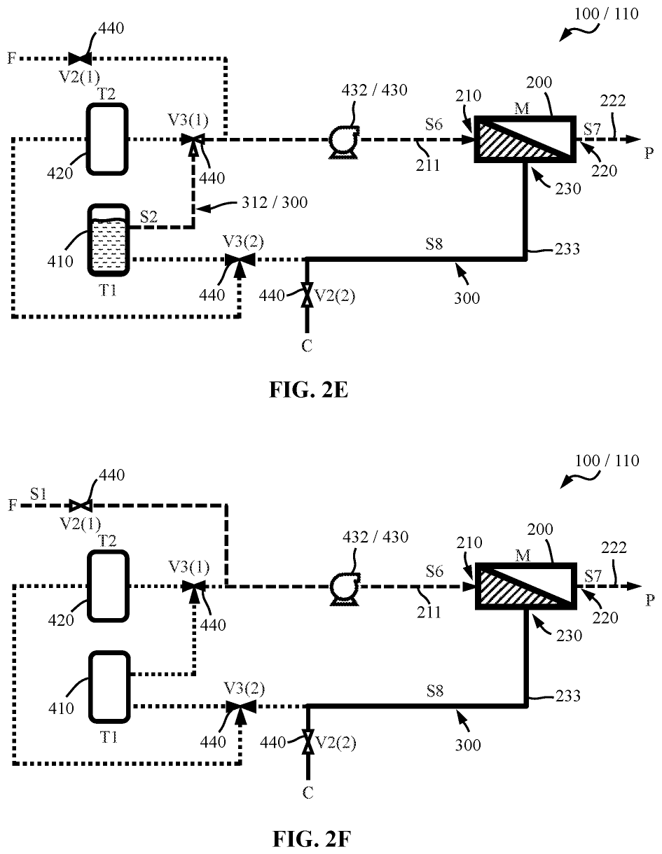

It will be understood by one skilled in the art that this does not preclude the system 100 from being physically connected to other components. For example, more than two tanks can be connected to the fluid circuit, in which the additional tanks can be used as spare containers to ensure a continuous intake of fresh feed. FIG. 2 shows another example of the system 100, in which the system 100 is configured for SCRO processes according to another embodiment of the present disclosure. The system 100 of FIG. 2 may be described as a system for SCRO without ERD. Only one pump 430, e.g., one high-pressure pump 432, is required for pressurizing the feed 211 (stream S6) drawn from a source which at any one time is no more than one of the following: fresh feed from the fresh feed inlet 102, the first tank 410 (tank T1), and the second tank 420 (tank T2).

To aid understanding, FIG. 1A shows the flow path 300 of an initial cycle (cycle 1) in a SCRO process with ERD in a system 100 of FIG. 1. FIG. 1B shows the flow path 300 in an even numbered cycle, i.e., cycle number i=2, 4, . . . , 2n, where 2n (n∈ [symbol] _{≥1}) in the SCRO process of FIG. 1. FIG. 1C shows the flow path 300 in an odd numbered cycle, i.e., cycle number i=3, 5, . . . , 2n−1, where 2n−1 (n∈ [symbol] _{>1}) in the SCRO process of FIG. 1. FIG. 1D shows the flow path 300 of a final cycle of the SCRO process of FIG. 1, in which the final cycle is an odd numbered cycle, i.e., cycle number i=N=2n−1 (n∈ [symbol] _{>1}). FIG. 1E shows the flow path 300 of a final cycle of the SCRO process of FIG. 1, in which the final cycle is an even numbered cycle, i.e., cycle number i=N=2n (n∈ [symbol] _{≥1}). Fig. w

Table 1 below shows the various stages of multi-cycle SCRO operations with reference to FIGS. 1A to 1F for SCRO processes with ERD.

TABLE 1

| | Start of a | Cycle | Cycle | Cycle | Cycle | | Cycle | Cycle |
|---|---|---|---|---|---|---|---|---|
| N | Cycle | 1 | 2 | 3 | 4 | . . . | 2n − 1 | 2n |
| 2 | FIG. 1F | FIG. 1A | FIG. 1E | — | — | — | — | — |
| cycles | | | | | | | | |
| 3 | FIG. 1F | FIG. 1A | FIG. 1B | FIG. 1D | — | — | — | — |
| cycles | | | | | | | | |
| 4 | FIG. 1F | FIG. 1A | FIG. 1B | FIG. 1C | FIG. 1E | — | — | — |
| cycles | | | | | | | | |
| 2n − 1 | FIG. 1F | FIG. 1A | FIG. 1B | FIG. 1C | FIG. 1B | . . . | FIG. 1D | — |
| cycles | | | | | | | | |
| 2n | FIG. 1F | FIG. 1A | FIG. 1B | FIG. 1C | FIG. 1B | . . . | FIG. 1C | FIG. 1E |
| cycles | | | | | | | | |

The sequence for SCRO process without ERD may be similarly presented with reference to FIGS. 2A to 2F. FIG. 2A shows the flow path 300 of an initial cycle (cycle number i=1) in a SCRO process without ERD in a system 100 of FIG. 2. FIG. 2B shows the flow path 300 in an even numbered cycle, i.e., cycle number i=2, 4, . . . , 2n, where 2n (n∈ [symbol] _{≥1}) in the SCRO process of FIG. 2. FIG. 2C shows the flow path 300 in an odd numbered cycle, i.e., cycle number i=3, 5, . . . , 2n−1, where 2n−1 (n∈ [symbol] >1) in the SCRO process of FIG. 2. FIG. 2D shows the flow path 300 of a final cycle of the SCRO process of FIG. 2, in which the final cycle is an odd numbered cycle, i.e., cycle number i=N=2n−1 (n∈ [symbol] _{>1}). FIG. 2E shows the flow path 300 of a final cycle of the SCRO process of FIG. 2, in which the final cycle is an even numbered cycle, i.e., cycle number i=N=2n (n∈ [symbol] _{≥1}). FIG. 2F shows the flow of liquid in a flushing operation through the system of FIG. 2.

For one intake of fresh feed received through the fresh feed inlet 102, the liquid may be directed through the system 100 in the following sequence: (i) the one intake of fresh feed received via the fresh feed inlet and directed as the feed 211 along the first feed flow path 311′ to the inlet 210 of the RO membrane module 200; (ii) in this initial cycle (FIG. 1A/FIG. 2A) the liquid received via the inlet 210 is separated by the RO membrane module 200 into the RO permeate 222 and the RO concentrate 233; (iii) the RO concentrate 233 out of the RO membrane module 200 is directed along the first concentrate flow path 331 from the concentrate outlet 230 to the first tank 410; (iv) as illustrated by FIG. 1B or FIG. 2B, liquid is drawn from the first tank 410 and forms the whole of the feed 211 that is now directed along the second feed flow path 312 to the inlet 210 of the RO membrane module 200; (v) in this subsequent cycle of liquid through the RO membrane module 200, the feed 211 is further separated into the RO permeate 222 and the RO concentrate 233; (vi) if the second cycle is a final cycle (FIG. 1E/FIG. 2E), the RO concentrate 233 out of the RO membrane module 200 is discharged out of the system 100. The RO permeate 222 from any or all of the cycles may be piped out of the system 100 for various purposes. A flushing operation (FIG. 1F or FIG. 2F) may be then performed to flush out remaining liquid in the system 100 before another intake of fresh feed is taken in via the fresh feed inlet 102 into the system 100.

On one hand, the present system 100 is not similar to a conventional open system in that, for the present system 100, each intake of fresh feed is cycled through the RO membrane module 200 for one or more cycles until all liquid is discharged out of the system 100 before another intake of fresh feed is received into the system 100. On the other hand, the flow path 300 of the present disclosure differs from a conventional closed system. For example, in a conventional closed reverse osmosis system, the conventional flow path leads from an RO membrane module to a tank and from the same tank to the RO membrane module. In the conventional closed reverse osmosis system, there is inevitable entropy generation, at least from the mixing of the feed and the concentrate in the tank. In contrast, in the present system 100, in each cycle, the feed and the concentrate are prevented from mixing in any tank. Thus, the system 100 of the present disclosure is also referred to herein as a semi-closed system.

The semi-closed reverse osmosis (SCRO) proposed herein is also characterized in the following aspects. Fresh feed only enters at the initial cycle (Cycle 1) while the RO concentrate is discharged in the final cycle after achieving the desired recovery. In each cycle after the initial cycle, the feed source is the concentrate solution collected from the previous cycle. The feed is pressurized and then dewatered in the RO membrane module. In each cycle, the RO concentrate flowing out from the RO membrane module is stored in a separate receiver tank other than the feed tank, forming a semi-closed loop during operation. The stored concentrate solution serves as the feed source for the next cycle. In a final cycle, the RO concentrate may optionally be discharged on exiting the RO membrane module without being stored in the receiver tank. Mixing between the concentrate stream and the feed stream is eliminated or prevented in the SCRO operations. The number of cycles for one intake of fresh feed can be changed flexibly in accordance with the properties of the feed (e.g., feed salinity) and recovery target, without altering the flow orientation in the fluid circuit. The number of cycles of the SCRO process is an operating parameter that can be optimized to lower energy consumption. In a series of cycles for desalination of one intake of liquid, the applied hydraulic pressure in each cycle is elevated compared to that in the previous cycle.

Referring still to FIGS. 1 and 2, the system 100 may further include a second tank 420, with the fluid circuit 110 coupling the second tank 420, the first tank 410, and the RO membrane module 200. For one intake of fresh feed received through the fresh feed inlet 102, the liquid may be directed through the system 100 in the following sequence: (i) the one intake of fresh feed received via the fresh feed inlet is directed along the first feed flow path 311′ to the inlet 210 and received as the feed 211 into the RO membrane module 200 (FIG. 1A/FIG. 2A); (ii) in this cycle through the RO membrane module 200, the feed 211 received via the inlet 210 is separated by the RO membrane module 200 into the RO permeate 222 and the RO concentrate 233; (iii) the RO concentrate 233 out of the RO membrane module 200 is directed along the first concentrate flow path 331 from the concentrate outlet 230 to the first tank 410; (iv) liquid from the first tank 410 forms the whole of the feed 211 that is then directed along the second feed flow path 312 to the inlet 210 of the RO membrane module 200; (v) in this subsequent cycle or subsequent pass of liquid through the RO membrane module 200, the liquid is further separated into the RO permeate 222 and the RO concentrate 233; (vi) the RO concentrate 233 out of the RO membrane module 200 is directed along the second concentrate flow path 332 from the concentrate outlet 230 to the second tank 420, and the RO permeate 222 exits the RO membrane module 200 via the permeate outlet 220 (FIG. 1B/FIG. 2B). No liquid is drawn out of the second tank 420 into the rest of the system 100 before the system 100 stops drawing liquid from the first tank 410. In this example, after substantially all the liquid in the first tank 410 has been depleted, i.e., after substantially all the liquid in the first tank 410 has been drawn out of the first tank 410, cycled through the RO membrane module 200, and stored in the second tank 420, the one or more valves in the system 100 may be controllably adjusted such that, following the aforesaid sequence, (vii) liquid is drawn from the second tank 420 and directed along the first feed flow path 311 to the inlet 210 of the RO membrane module 200 (FIG. 1C/FIG. 2C); (viii) in the RO membrane module 200, the feed 211 is separated into the RO concentrate 233 and the RO permeate 222; (ix) if the current cycle is not the final cycle, the RO concentrate 233 out of the RO membrane module 200 is directed from the concentrate outlet 230 to the first tank 410. No liquid is drawn out of the first tank 410 into the rest of the system 100 before the system 100 stops drawing liquid from the second tank 420. In this example, after substantially all the liquid in the second tank 420 has been depleted, i.e., after substantially all the liquid in the second tank 420 has been cycled through the RO membrane module 200 and stored in the first tank 410, the one or more valves in the system 100 may be controllably adjusted for another cycle of the liquid through the RO membrane module 200 or for the liquid to be discharged out of the system 100. If this cycle is a final cycle (FIG. 1D/FIG. 2D), the RO concentrate 233 out of the RO membrane module 200 is discharged out of the system 100. A flushing operation (FIG. 1F/FIG. 2F) may be performed after the final cycle, e.g., water may be pumped into the system 100 via the fresh feed inlet 102, passed through at least the RO membrane module 200, and then discharged out of the system 100.

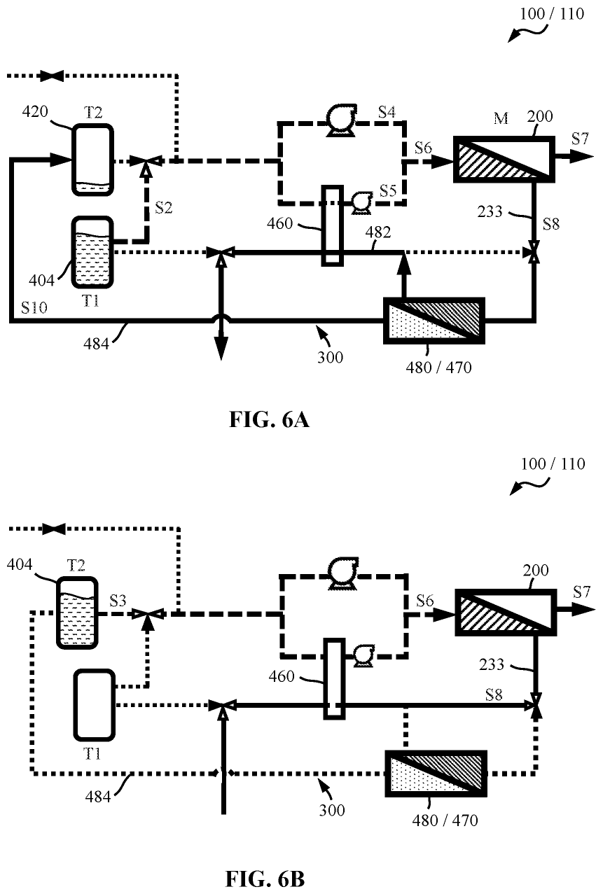

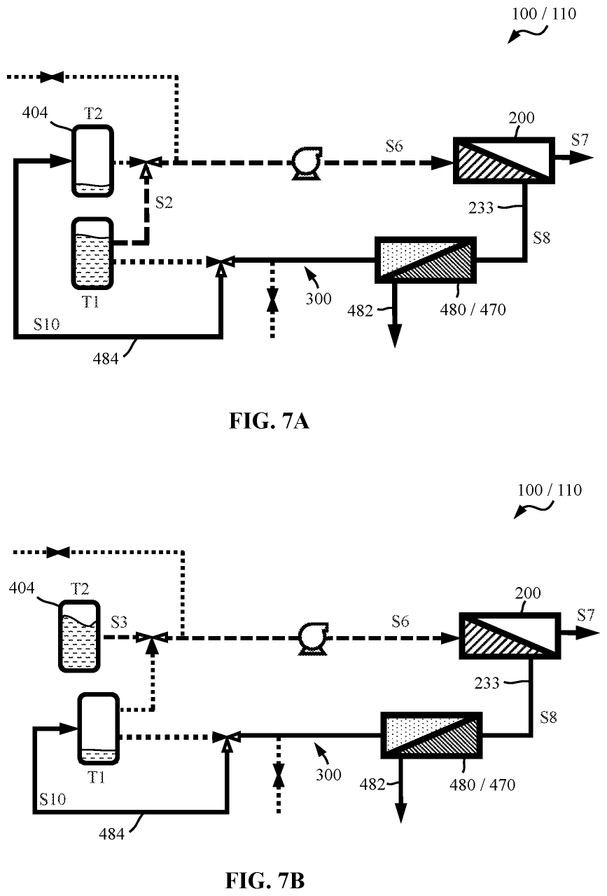

In some embodiments, in the final cycle, the RO concentrate 233 out of the RO membrane module 200 may be discharged out of the system 100 after passing through an energy recovery device 460 (FIG. 1D/FIG. 1E) and/or a treatment unit 470 (e.g., FIGS. 6A-7B).

Referring to either FIG. 1 or FIG. 2, alternatively described, the fluid circuit 110 configuration shows a flow path 300 in which liquid is directed along a first feed flow path 311, through the RO membrane module 200, along the first concentrate flow path 331 to the first tank 410, and then along a second feed flow path 312 from the first tank 410 back to the RO membrane module 200, in which the first feed flow path 311 and the second feed flow path 312 are not identical.

Alternatively described, the fluid circuit 100 is configured to provide the flow path 300 in which the flow path 300 includes the first feed flow path 311, the first concentrate flow path 331, and the second feed flow path 312. In operation, the feed 211 is directed along the first feed flow path 311 to the inlet 210 of the RO membrane module 200. The RO concentrate 233 is directed along the first concentrate flow path 331 from the concentrate outlet 230 of the RO membrane module 200 to the first tank 410. From the first tank 410, the feed 211 is directed along the second feed flow path 312 to the inlet 210 of the RO membrane module 200. The first feed flow path 311 and the second feed flow path 312 are successive feeds 211 to the same inlet 210 of the RO membrane module 200, and each of the first feed flow path 311 and the second feed flow path 312 receives their respective feed 211 from different sources. For example, in a current cycle, the second feed flow path 312 may be configured to receive the feed 211 from the first tank 410, and in a subsequent cycle, the first feed flow path 311 is configured not to receive the feed 211 from the first tank 410. For example, in an initial cycle, the first feed flow path 311 may receive the feed 211 from a fresh feed inlet 102 without the liquid being previously stored in or passed through any of the first tank 410 and the second tank 420, and in a subsequent cycle, the second feed flow path 312 may receive the feed 211 from one of the first tank 410 and the second tank 420.

For convenient reference, in the present disclosure, a first cycle refers to a cycle in which the feed 211 is directed along the first feed flow path 311 to the RO membrane module 200. For example, in the first cycle, the feed 211 may be received from the second tank 420 and directed along the first feed flow path 311 to the RO membrane module 200. In this example of the first cycle, the second tank 420 serves as a feed tank 402 and also as the sole source of the feed 211. In the first cycle, the RO concentrate 233 may be directed along the first concentrate flow path 331 from the RO membrane module 200 to the first tank 410. In this example of the first cycle, the first tank 410 serves as a receiver tank 404. Only one of the first tank 410 and the second 420 is used as the receiver tank 404 in any one cycle, and in the first cycle, the first tank 410 is the sole storage tank for the RO concentrate 233. The first feed flow path 311 and the first concentrate flow path 331 do not converge at any point that is simultaneously upstream of the inlet 210 of the RO membrane module 200 and downstream of the second tank 420. That is, in any cycle, the feed 211 at the inlet 210 of the RO membrane module 200 is not a convergence of liquid from the feed tank 402 and liquid from the receiver tank 404.

For convenient reference, in the present disclosure, a second cycle refers to a cycle in which the feed 211 is directed along the second feed flow path 312 to the RO membrane module 200. For example, in the second cycle, the feed 211 may be received from the first tank 410 and directed along the second feed flow path 312 to the RO membrane module 200. In this example of the second cycle, the first tank serves as the feed tank 402 and also as the sole source of the feed 211. In the second cycle, the RO concentrate 233 may be directed along the second concentrate flow path 332 from the RO membrane module 200 to the second tank 420. In this example of the second cycle, the second tank serves as the receiver tank 404. Only one of the first tank 410 and the second tank 420 is used as the receiver tank 404 in any one cycle, and in the second cycle, the second tank 420 is the sole storage tank for the RO concentrate 233. The second feed flow path 312 and the second concentrate flow path 332 do not converge at any point that is simultaneously upstream of the inlet 210 of the RO membrane module 200 and downstream of the first tank 410. That is, in any cycle, the feed 211 at the inlet 210 of the RO membrane module 200 is not a convergence of liquid from the feed tank 402 and liquid from the receiver tank 404. The fluid circuit 110 may be configured to prevent a direct flow path of liquid from the receiver tank 404 to the feed tank 402 or from the feed tank 402 to the receiver tank 404 within each of any two successive cycles, in which the direct flow path refers to a shortest possible flow path between two points in the fluid circuit 110 without passing through the RO membrane module 200. That is, the direct flow path does not pass through the RO membrane module 200.

In some embodiments, the system 100 is configured such that the first cycle and the second cycle are successive cycles of at least two cycles of liquid through the RO membrane module 200. In preferred embodiments, one intake of fresh feed is cycled through the RO membrane module 200 for at least two cycles. In any one cycle of the at least two cycles (for the sake of brevity, in the present disclosure, the any one cycle may also be referred as a current cycle), the RO concentrate 233 of the current cycle is prevented from mixing with the feed 211 of the same current cycle. The fluid circuit 110 may be configured to alternate between providing the first feed flow path 311 in the first cycle and providing the second feed flow path 312 in the second cycle. For example, one or more valves 440 may be used to determine which liquid the high-pressure pump 432 receives. For example, in the first cycle, the three-way valve V3(1) may have all three ports closed (FIG. 1A) or only the port leading from the first tank 410 closed (FIG. 1C) such that the high-pressure pump 432 receives liquid via the first feed flow path 311/311′ from the fresh feed inlet 102 (FIG. 1A) or from the second tank 420 and not from the first tank 410 (FIG. 1C); and in the second cycle, the three-way valve V3(1) may have only the port leading from the second tank 420 closed (FIG. 1B) such that the high-pressure pump 432 receives liquid via the second feed flow path 312 from the first tank 410 and not from the second tank 420. That is, the first tank 410 may be configured to alternately serve as the feed tank 402 (to provide the feed 211 in a current cycle) and as the receiver tank 404 (to receive the RO concentrate 233 in a subsequent cycle), in which the subsequent cycle is a cycle immediately following the current cycle. Alternatively, the second tank 420 may be configured to alternately serve as the feed tank 402 (to provide the feed 211 in a current cycle) and as the receiver tank 404 (to receive the RO concentrate 233 in a subsequent cycle), in which the subsequent cycle is a cycle immediately following the current cycle.

The system 100 may include one or more pumps 430 and one or more valves 440 to enable the liquid in the fluid circuit 110 to flow along the flow path 300 described above. For the sake of brevity, in the present disclosure, “a pump” 430 may refer to any type and/or number of units of pumps, including but not limited to one or more hydraulic pumps, one or more high pressure pumps, one or more booster pumps, or any combination thereof, etc. In operation, the pump 430 pushes the liquid along the flow path 300 and/or deliver the liquid at a pressure. The one or more valves 440 may include, but are not limited to, one or more two-way valves, one or more three-way valves, or any combination thereof, etc. One skilled in the art would understand that there are a variety of locations which may be selected for installing the pump 430 and the one or more valves 440 in the system 100 to implement various embodiments of the fluid circuit 110 described above. The configurations shown in the appended figures are therefore non-limiting examples illustrated to aid understanding. For the sake of brevity, the system 100 may be described as having a pump 430 that is coupled to the fluid circuit 110, in which the pump 430 is configured to deliver the feed 211 to the inlet 210 at a target pressure. The pump 430 is configured to alternate between (i) receiving the feed 211 from the second tank 420 in the first cycle and (ii) receiving the feed 211 from the first tank 410 in the second cycle.

In some embodiments, the system 100 may be described as including a high-pressure pump 432 disposed upstream of the inlet 210 of the RO membrane module 200 and downstream from the feed tank 402, in which the high-pressure pump 432 is configured to increase the pressure of the feed 211. In some embodiments, the system 100 further includes an energy recovery device 460 in parallel with the high-pressure pump 432. The ERD 460 may be configured to recover energy from the RO concentrate 233 downstream of the RO membrane module 200 and to use the recovered energy to at least partially pressurize the feed 211 upstream of the RO membrane module 200. In some embodiments, the system 100 further includes a booster pump 434 in series with the energy recovery device 460, with both the booster pump 434 and the energy recovery device 460 coupled in parallel with the high-pressure pump 432. The booster pump 434 may be used to boost the pressure of the pressurized stream after or downstream of the energy recovery device 460 to a desired level.

The RO concentrate 233 out of the RO membrane module 200 is characterized by an osmotic pressure for each cycle of at least two cycles of liquid through the RO membrane module 200, in which the feed 211 of each cycle is delivered to the inlet 210 of the RO membrane module 200 at a target pressure. The target pressure is controllably variable between any of the at least two successive cycles such that the target pressure is at least minimally greater than the osmotic pressure of the RO concentrate 233 out of the RO membrane module 200 in the current cycle. The system 100 may include a pump 430 coupled to the fluid circuit 110, in which the pump 430 is configured to deliver the feed 211 to the inlet 210 of the RO membrane module 200 at a target pressure. In preferred embodiments, the pump 430 is configured to progressively increase the target pressure with each of the successive cycles.

The system 100 may be configured to initiate a discharge of any remaining liquid in the fluid circuit 110 and/or in any of the first tank 410 and the second tank 420. The discharge may be initiated in response to a recovery parameter reaching a threshold value. The recovery parameter may be determined based on a condition of the RO permeate at the permeate outlet, a condition of the feed 211, a condition of the RO concentrate out of the RO membrane module 200, a specific energy consumption, a number of cycles, a permeate flowrate (of the RO permeate), or any combination, derivative, or function thereof. Some of the conditions may be determined or sensed by one or more sensors situated at part of the fluid circuit 110. For example, a flow meter may be installed at the permeate outlet 220 to measure the permeate flowrate. In another example, a sensor may be installed at the inlet 210 or upstream of the inlet 210 in order to determine the water quality of the feed 211, etc.

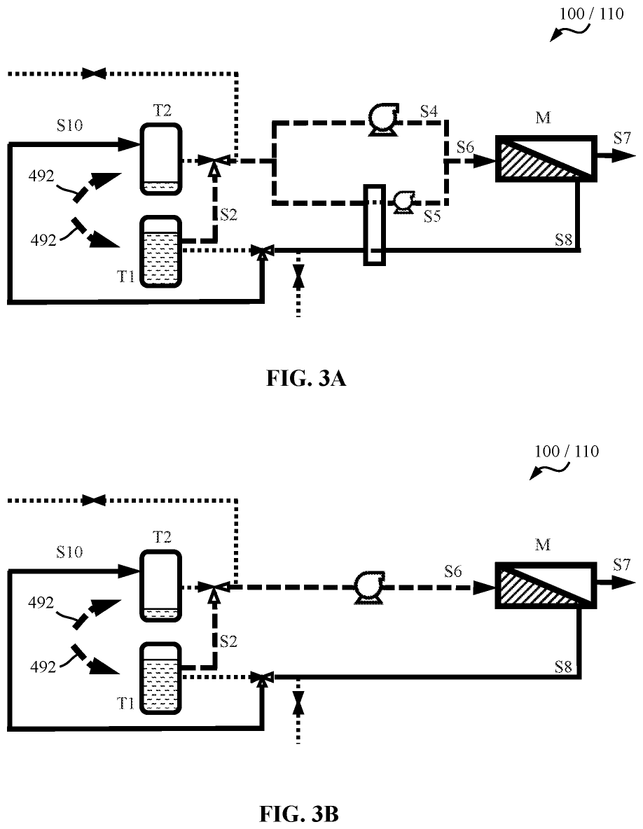

In some embodiments, as illustrated schematically in FIG. 3A (SCRO with ERD) and FIG. 3B (SCRO without ERD), in the system 100, chemical dosages 492 may be added directly to the liquid in either or both of the first tank 410 and the second tank 420. This is preferably for cases where the chemical dosages will not induce formation of non-dissolvable particles. The chemical dosages may be selected from any one or more of the following: chemicals to adjust pH, chemicals to adjust alkalinity, anti-scalants, disinfectants, oxidants, etc.

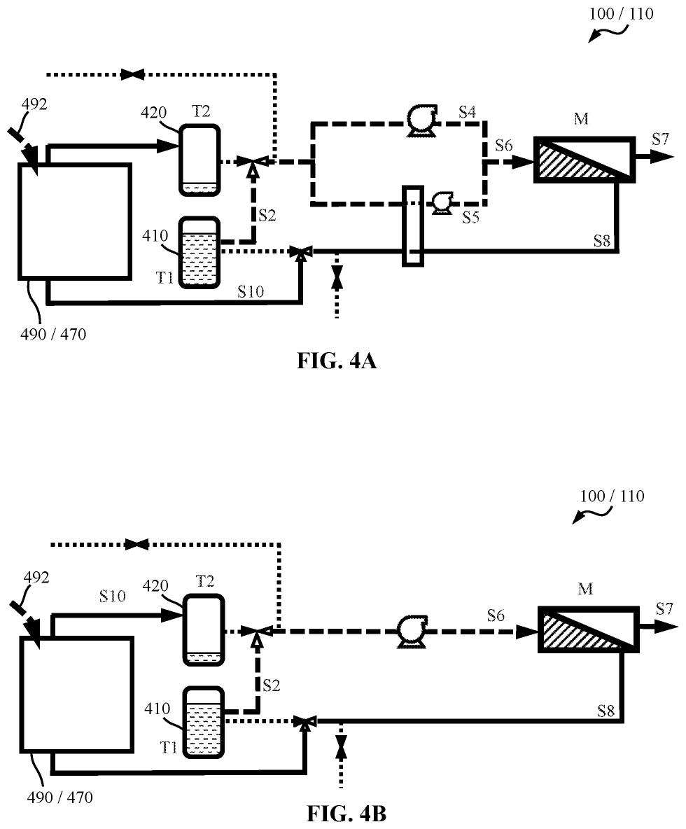

In some embodiments, the system 100 includes an external treatment unit 470 having one or more third tank 490 (i.e., a third tank 490 or a plurality of third tanks 490), as schematically illustrated in FIG. 4A (SCRO with ERD) and FIG. 4B (SCRO without ERD). The one or more third tank 490 may be useful in installations where the chemical dosages may or will induce the formation of non-dissolvable particles. Such chemical dosages which may promote or result in coagulation, flocculation, sedimentation, chemical precipitation, etc., may be added to the liquid in the one or more third tank 490 rather than added directly to any of the first tank 410 or the second tank 420. The non-dissolvable parties may be allowed to settle in the one or more third tank 490 and the treated liquid can then be drawn off and directed to the intended receiver tank 404.

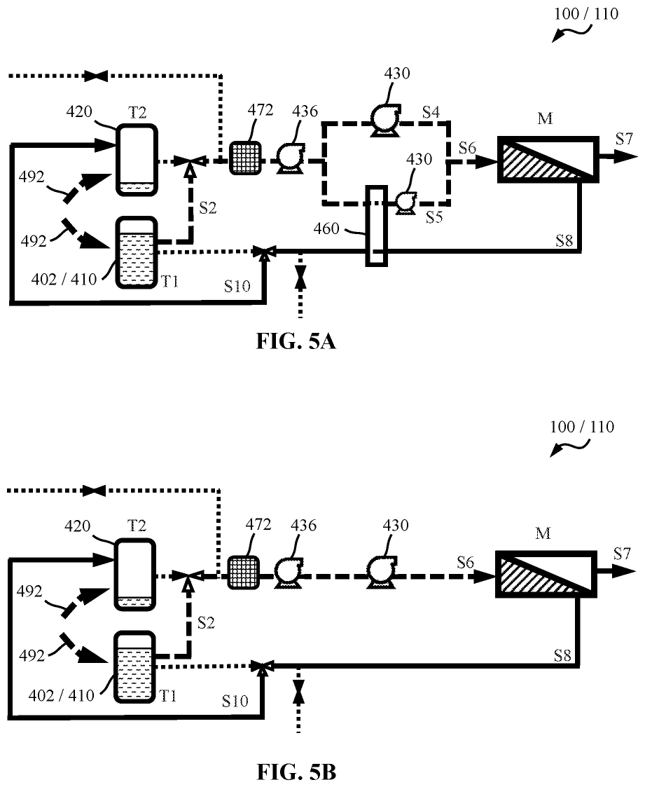

In some embodiments, a filtration unit 472 may be added downstream of the feed tank 402 and upstream of a pump 430 (e.g., an intake pump 436) as illustrated in FIG. 5A (SCRO with ERD) and FIG. 5B (SCRO without ERD). In such installations, chemical dosages may be added directly to either or both of the first tank 410 and the second tank 420. Even if the chemical dosages result in the formation of non-dissolvable particles, such particles may be filtered out by the filtration unit 472.

In some embodiments, the system 100 for SCRO with ERD 460 may include a second stage purification. FIG. 6A schematically illustrates the system 100 configured to provide a flow path 300 of a cycle, in which the RO concentrate 233 (from the RO membrane module 200) is configured to pass through a secondary membrane module 480 such that the RO concentrate 233 is subjected to a filtering or fouling/scaling mitigation process. The term “secondary membrane module” as used herein refers to an apparatus which may include one or more membrane or elements configured to filter out impurities, such as but not limited to insoluble particles, foulants, precipitates, crystals that may have formed in the RO concentrate from the RO membrane module 200. The secondary membrane module 480 may include an apparatus configured to mitigate fouling and/or scaling in the next cycle of the RO membrane module. Preferably, the secondary membrane module 480 includes at least one membrane having a looser pore structure than that of the RO membrane module 200. Examples of the secondary membrane module 480 may include, but are not limited to, one or more of a low-salt-rejection reverse osmosis (LSRRO) membrane module, a nanofiltration (NF) membrane module, an ultrafiltration (UF) membrane module, a microfiltration (MF) membrane module, or any combination thereof. The one or more secondary membrane module 480 may be coupled to fluid circuit 110 at the RO concentrate 233 (stream S8). The secondary permeate out of the secondary membrane module 480 can be delivered to the receiver tank 404. The secondary retentate out of the secondary membrane module 480 may be passed through the ERD 460 for energy recovery before the liquid is discharged out of the system 100. FIG. 6B shows the flow path of the final cycle where the secondary membrane module 480 may be by-passed, and in which the RO concentrate 233 from the RO membrane module 200 is discharged out of the system 100 after energy recovery.

In some embodiments, the system 100 for SCRO without ERD may include a second stage purification. FIG. 7A schematically illustrates a flow path 300 of a cycle passing through one or more secondary membrane module 480 that is coupled to fluid circuit 110 at the RO concentrate 233 (stream S8). The secondary permeate out of the secondary membrane module 480 can be delivered to the receiver tank 404. The secondary retentate out of the secondary membrane module 480 may be discharged out of the system 100. FIG. 7B shows the flow path of the final cycle in which the RO concentrate 233 from the RO membrane module 200 is passed through the secondary membrane module 480. The secondary retentate 482 of the secondary membrane module 480 may be discharged out of the system 100. The secondary permeate 484 of the secondary membrane module 480 may be directed to the receiver tank 404.

Preferably, the secondary membrane module 480 is installed in the fluid circuit 110 where it only treats the liquid exiting from the RO membrane module 200.

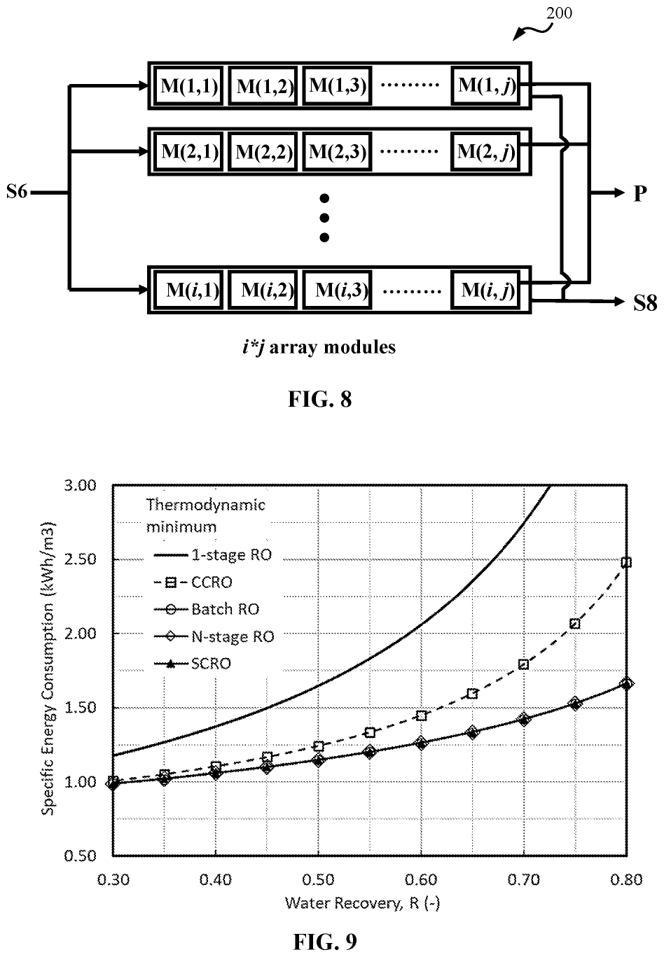

The various embodiments of the SCRO system proposed herein (with ERD or without ERD) may be implemented with various different types of RO membrane modules. The RO membrane module 200 may be either a single membrane module or an array of parallel membrane modules (as schematically illustrated in FIG. 8), each of which may include a pressure vessel containing one or serval membrane elements.

FIG. 9 is a plot showing the ideal thermodynamic minimum SEC as a function of recovery for various conventional RO processes and for one exemplary SCRO with ERD, for seawater desalination. In this exemplary scenario, the SCRO with ERD performs comparably with conventional batch RO (BRO) and conventional multiple-stage RO (also referred to as MSRO or N-stage RO) despite the SCRO with ERD having a significantly smaller physical footprint and requiring fewer hardware installations. This example of the SCRO with ERD outperforms the conventional single-stage RO (also referred to as a 1-stage RO) and the conventional closed-circuit RO (CCRO).

The SCRO process proposed herein can be used in various liquid processing, separation, and treatment, including but not limited to seawater desalination, brackish water desalination, wastewater desalination, wastewater reclamation, crude oil fractionation, organic solvent separation, and recovery, etc. In one example, the performance of an SCRO with ERD system for commercial seawater desalination may be approximated by the analytical model described below.

In the following, V_{ƒ,1}, C_{ƒ,1} and π_{ƒ,1} are the volume, concentration, and osmotic pressure of the feed 211 entering the RO membrane module 200 at the initial cycle. The total permeate volume, Vₚ is calculated as:

$${V}_{p} = {V}_{f , 1} \times R \qquad Equation ( 1 )$$

where R is the overall recovery of the SCRO. For a SCRO operation with N cycles and a cycle recovery of r, the concentrate volume collected in the i^{th} cycle, V_{c,i}, is derived by,

$${V}_{c , i} = {( 1 - r )}^{i} \times {V}_{f , 1} \qquad Equation ( 2 )$$

V_{c,i} is also the feed volume of the subsequent cycle, hence

$${V}_{f , i} = {V}_{c , i - 1} = {( 1 - r )}^{i - 1} \times {V}_{f , 1} \qquad Equation ( 3 )$$

The SECs of the SCRO system are derived as,

$$SEC = \frac{\begin{matrix}{\sum }_{i = 1}^{i = N} ( ( {P}_{F , i} + Δ {P}_{Loss} ) {( 1 - r )}^{i - 1} ) - \\ {\sum }_{i = 1}^{i = N} [ {{P}_{F , i} ( 1 - r )}^{i} ] \times {η}_{ERD}\end{matrix}}{R \times {η}_{P}} \qquad Equation ( 4 )$$

where np and NERD are the efficiency of pump and the efficiency of ERD, respectively. ×P_{Loss} is the pressure loss at the i^{th} cycle. The minimal pressure applied to the i^{th} cycle, P_{F,i}, equals to the osmotic pressure of the exiting RO concentrate.

$${P}_{F , i} = \frac{{π}_{f , 1}}{{( 1 - r )}^{i}} \qquad Equation ( 5 )$$

Note that,

$$1 - r = {( 1 - R )}^{\frac{1}{N}} \qquad Equation ( 6 )$$

and that,

$${\sum }_{i = 1}^{i = N} {( 1 - r )}^{i} = \frac{R}{r} \qquad Equation ( 7 )$$

the equation of SEC can be simplified as,

$$SEC = \frac{{π}_{f , 1}}{{η}_{P}} [ \frac{N}{R ( 1 - r )} - {η}_{ERD} \frac{N}{R} + \frac{Δ {P}_{Loss}}{{π}_{f , 1} r} ] \qquad Equation ( 8 )$$

The performance of the SCRO process is compared with other RO processes with the following assumptions:
(i) the feed inlet concentration C_{ƒ,1}=0.6 M;
(ii) water recovery R=30%-80% for seawater desalination;
(iii) pump efficiency ηₚ=80%, pressure exchanger efficiency η_{ERD}=98%;
(iv) pressure loss per stage or cycle, ΔP_{Loss}=0.1, 0.2 or 1 bar; and
(v) all systems are operated at optimal operating conditions.

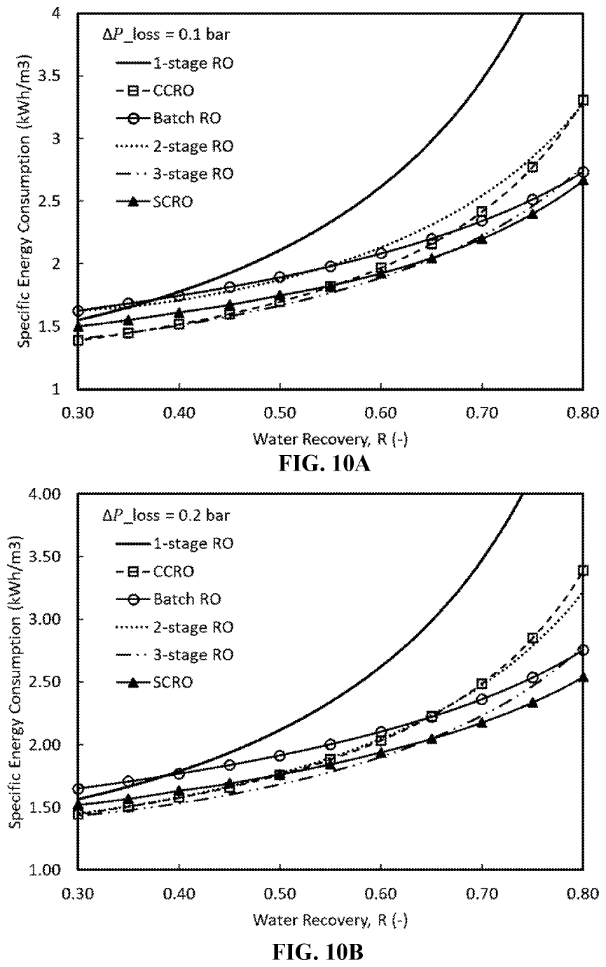

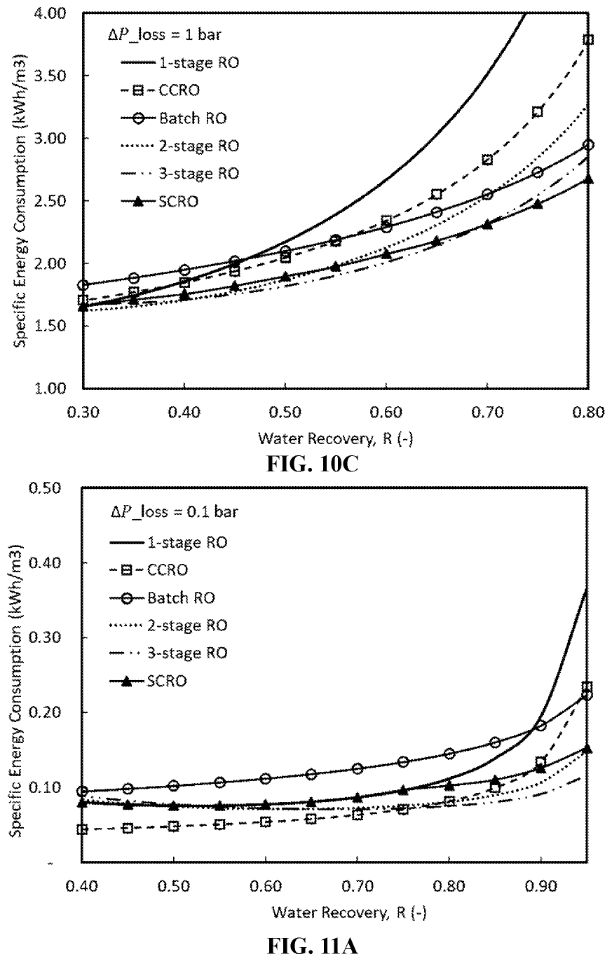

FIGS. 10A to 10C compare the theoretical specific energy consumption of the proposed SCRO process (calculated based on Equation (8) above) with the specific energy consumption of other conventional reverse osmosis (RO) processes for seawater desalination, in which practical inefficiencies and losses are taken into consideration. The conventional RO systems compared include the conventional single-stage reverse osmosis (SSRO), the conventional multi-stage reverse osmosis (MSRO), the conventional closed-circuit reverse osmosis (CCRO), and the conventional batch reverse osmosis (BRO) under 3 different sets of pressure loss conditions, ΔP_{Loss}=0.1 bar (FIG. 10A), 0.2 bar (FIG. 10B), and 1 bar (FIG. 10C) respectively. In these theoretical calculations, the pressures applied to each system equal to the exiting concentrate osmotic pressures and the membrane areas are unlimited. In particular, the SCRO has a lower SEC than either the conventional BRO process and the conventional CCRO process, especially when ΔP_{circ} is significant and the recovery is high (>50%). This suggests that there is less energy loss and less entropy generation in the SCRO processes compared to conventional RO processes.

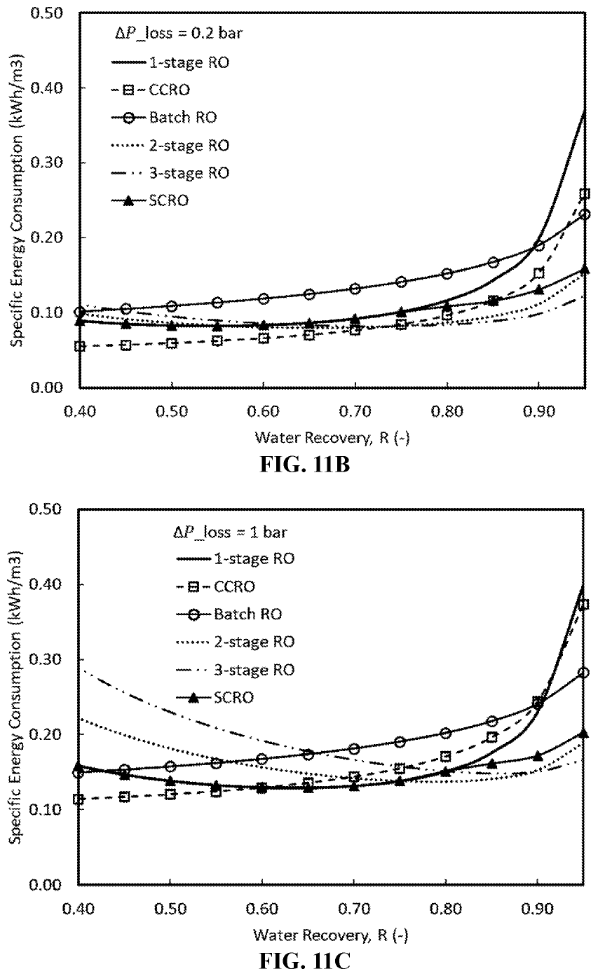

FIG. 11A (0.1 bar pressure loss per stage), FIG. 11B (0.2 bar pressure loss per stage), and FIG. 11C (1 bar pressure loss per stage) show a similar comparison but for wastewater desalination instead of seawater desalination. The assumptions are similar to those given for the seawater desalination example, except in the following:
(i) Wastewater with a concentration C_{ƒ,1}=500 ppm is applied as feed solution.
(ii) All systems compared in this section are operated without the use of ERD, i.e., by setting η_{ERD}=0%.
(iii) Water recovery R=40%-95%.

While the proposed SCRO process may not exhibit the lowest SEC among the various RO processes, it offers comparable performance even at a low-pressure loss. The SCRO process can be applied to seawater desalination and wastewater desalination, owing to its capability to switch the number of operating cycles and recovery to minimize the energy consumption. This is not possible using the conventional MSRO and the conventional single stage design with preset number of stages. The SCRO system is also configured to mitigate the effect of mixing the concentrate and the feed by storing the intermediate brine in a separate tank other than the feed tank.

As shown by the comparisons made above, the SCRO process proposed herein can mitigate over-pressurization of the feed and also reduce (or even eliminate) entropy generation and energy wastage. The exemplary SCRO apparatus and method described above also provide a comparatively compact system while enabling flexible operation. The hardware of the system 100 does not have to be reconfigured to perform different number of cycles for one intake of fresh feed. Various levels of recovery can be achieved by varying the number of cycles in a multi-cycle operation, without the need to make changes to the physical hardware of the system. The hydraulic pressure applied is variable over the cycles. Inter-stage booster pumps are not required. Advantageously, as demonstrated, the semi-closed reverse osmosis proposed herein is characterized by reduced energy consumption compared to various other conventional methods.

The proposed SCRO apparatus and method provide many advantages. Compared to the conventional SSRO, the SCRO can potentially reduce energy consumption with lower applied pressures. If more than one cycle is adopted, the required hydraulic pressure in SCRO can be reduced for all the cycles before the final cycle to take advantage of the lower osmotic pressure of the RO concentrate (i.e., the osmotic pressure of the final concentrate exiting the system is highest among the cycles). Over-pressurization of low-salinity feed can be mitigated in this manner.

Each cycle in SCRO may be treated as corresponding to a stage of the conventional MSRO process. In the SCRO, when used for high concentration saltwater desalination or liquid separation (e.g., seawater desalination), the pressure will be boosted to a higher level compared to the previous cycle in each cycle of the SCRO. This may be similar to MSRO operation at different stages. However, the MSRO require installation of an inter-staging pressure boosting device (e.g., booster pump) between the two adjacent stages. The SCRO process does not need inter-stage pressure boosting devices to be installed. By altering the number of cycles in an SCRO process, the SCRO system with only one set of circulation pump can function as though it is a MSRO system. However, in the MSRO system, multiple booster pumps have to be installed between the multiple stage. Thus, the SCRO can advantageously provide considerable cost savings while delivering comparable or improved performance.

Compared to the conventional SSRO and the conventional MSRO, the RO membranes of the proposed SCRO are expected to experience less fouling and longer usable life. This is because the SCRO can use shorter pressure vessels with fewer number of elements connected in series inside the pressure vessel. This advantageously results in a more evenly distributed flux along the RO membrane module. Unlike long modules used in conventional SSRO and MSRO where the front elements experience very high flux while the tail elements experience very low flux, the front elements in SCRO can be operated at lower flux and this in turn can reduce the fouling potential. In addition, at different cycles, solutions of different concentrations will flow into the RO membrane modules. This varying concentration can potentially destabilize any foulant previously deposited at the membranes and help remove foulants deposited from previous cycles.

The operation of the proposed SCRO is flexible. It can be operated at different cycles depending on the recovery to be achieved. The number of cycles can be optimized in order to minimize the energy consumption in different operating conditions.

Compared to the conventional CCRO and conventional BRO, the proposed SCRO method avoids the mixing between the RO concentrate and feed solution by storing the concentrate solution into a separate container. This helps to eliminate the entropy generation during the mixing of concentrate and feed, i.e., irreversible energy loss can be avoided or reduced.

Compared to the conventional CCRO, the operation of the proposed SCRO is much easier as the SCRO can use a conventional ERD instead of a pressurized side-conduit (SC) for energy recovery. Unlike CCRO and BRO, the SCRO does not require the continuous increase of pressure. The applied hydraulic pressure in each cycle of SCRO can be constant while the energy recovery is achieved via an ERD, which is similar to SSRO.

Compared to the conventional CCRO, the flushing period of the SCRO between desalination batches occupies a smaller proportion of total desalination time since most of the liquid has been discharged before the final cycle of the SCRO. In the conventional CCRO, all concentrate is discharged during the flushing period, and a proportionally longer proportion of desalination time is required for performing flushing. In another aspect, the proposed SCRO is characterized by a lower energy consumption during the period for flushing residual concentration in the module than the conventional CCRO.

Compared to the conventional BRO, the proposed SCRO can save the plant footprint due to a smaller tank capacity requirement.

Advantageously, the SCRO can be implemented by retrofitting existing SSRO systems without expensive acquisition of major equipment (e.g., pumps, ERDs).

The tank-switching configuration of the proposed SCRO system allows the chemicals to be added to the concentrate storage tank and stirred well with the concentrate solution before the concentrate is fed to the system in the subsequent cycle. Since the volume of RO concentrate generated in each of the intermediate cycles is smaller than that of one intake of fresh feed, this means that the proposed SCRO would require less chemicals for use in water treatment/liquid processing. Depending on the extent of fouling at different cycles, the choice of adding chemicals at which cycle can be adjusted. SCRO also provide the option of adding chemicals at later cycles so that the amount of chemicals required is proportionally smaller since there is a smaller volume of RO concentrate to be treated. This not only save on chemicals and costs, it would also be more environmentally conscious and sustainable. Therefore, the SCRO with a multi-cycle operation can potentially avoid adding a significant amount of added chemicals (such as anti-fouling and anti-scaling additives, antifoaming additives, and oxygen scavengers) to the liquid being treated.

All examples described herein, whether of apparatus, methods, materials, or products, are presented for the purpose of illustration and to aid understanding and are not intended to be limiting or exhaustive. Various changes and modifications may be made by one of ordinary skill in the art without departing from the scope of the invention as claimed.

1. A system comprising:
a reverse osmosis (RO) membrane module having an inlet, a permeate outlet, and a concentrate outlet, the RO membrane module being operable to separate a feed into a RO permeate and a RO concentrate, the RO concentrate being delivered out of the RO membrane module via the concentrate outlet;
a first tank; and
a fluid circuit, the fluid circuit coupling the RO membrane module and the first tank, the
fluid circuit being configured to provide a flow path including:
a first feed flow path directing the feed to the inlet;
a first concentrate flow path directing the RO concentrate from the concentrate outlet to the first tank; and
a second feed flow path directing the feed from the first tank to the inlet, wherein the first feed flow path and the second feed flow path are configured to receive the feed from different sources.

2. The system of claim 1, further comprising:
a second tank, the second tank being coupled to the fluid circuit, wherein the fluid circuit is configured to alternate between providing the first feed flow path in a first cycle and providing the second feed flow path in a second cycle, the first cycle and the second cycle being successive cycles of at least two cycles of liquid through the RO membrane module, wherein:
in the first cycle, the feed is received from the second tank and directed along the first feed flow path to the RO membrane module, the second tank serving as a feed tank in the first cycle; and
in the first cycle, the RO concentrate is directed along the first concentrate flow path from the RO membrane module to the first tank, the first tank serving as a receiver tank in the first cycle, and
wherein:
in the second cycle, the feed is received from the first tank and directed along the second feed flow path to the RO membrane module, the first tank serving as the feed tank in the second cycle; and
in the second cycle, the RO concentrate is directed along a second concentrate flow path from the RO membrane module to the second tank, the second tank serving as the receiver tank.

3. The system according to claim 2, wherein in the first cycle, the first feed flow path and the first concentrate flow path do not converge upstream of the inlet and downstream of the second tank, and wherein in the second cycle, the second feed flow path and the second concentrate flow path do not converge upstream of the inlet and downstream of the first tank.

4. The system according to claim 2, wherein the RO concentrate of a current cycle is prevented from mixing with the feed of the current cycle, the current cycle being any one of the at least two cycles.

5. The system according to claim 4, wherein each of the first tank and the second tank is configured to alternately serve as the feed tank to provide the feed in the current cycle and as the receiver tank to receive the RO concentrate in a subsequent cycle, the subsequent cycle immediately following the current cycle.

6. The system according to claim 2, wherein the fluid circuit is configured to prevent a direct flow path of liquid from the receiver tank to the feed tank within each of the at least two cycles, in which the direct flow path does not pass through the RO membrane module.

7. The system according to claim 2, wherein the RO concentrate out of the RO membrane module is characterized by an osmotic pressure for each of the at least two cycles, and wherein the feed of each cycle is delivered to the inlet at a target pressure, the target pressure being controllably variable between any of the at least two cycles such that the target pressure is at least minimally greater than the osmotic pressure of the RO concentrate out of the RO membrane module in the current cycle.

8. The system according to claim 2, further comprising:
a pump coupled to the fluid circuit, the pump being configured to deliver the feed to the inlet at a target pressure, wherein the pump is configured to progressively increase the target pressure with each of the successive cycles.

9. The system according to claim 8,
wherein the pump is configured to alternate between (i) receiving the feed from the second tank in the first cycle and (ii) receiving the feed from the first tank in the second cycle.

10. The system according to claim 7, further comprising:
an energy recovery device coupled to the fluid circuit, the energy recovery device being configured to recover energy from the RO concentrate, wherein the energy recovery device is configured to at least partially pressurize the feed.

11. The system according to claim 2, wherein the fluid circuit further comprises a fresh feed inlet configured to receive one intake of fresh feed, and wherein the one intake of fresh feed is cycled through the RO membrane module for the at least two cycles.

12. The system according to claim 11, wherein the system is configured to initiate a discharge of remaining liquid in the fluid circuit and in any of the first tank and the second tank, and wherein the discharge is initiated in response to a recovery parameter reaching a threshold value.

13. The system according to claim 12, wherein the recovery parameter is determined based on a condition of the RO permeate at the permeate outlet, a condition of the feed, a condition of the RO concentrate out of the RO membrane module, a specific energy consumption, a number of cycles, a permeate flowrate, or any combination thereof.

14. The system according to claim 2, further comprising a treatment unit, the treatment unit being configured to provide at least one chemical dosage to respective contents of one or both of the feed tank and the receiver tank.

15. The system according to claim 14, wherein the treatment unit comprises one or more third tank configured to receive the RO concentrate from the RO membrane module and to deliver a treated concentrate to the receiver tank, wherein the treatment unit is configured to provide the at least one chemical dosage to the one or more third tank and to provide for at least partial settlement of non-dissolvable particles in the one or more third tank before the treated concentrate is delivered to the receiver tank.

16. The system according to claim 14, further comprising a filtration unit coupled to the fluid circuit, the filtration unit being configured to filter the feed received from the feed tank.

17. The system according to claim 2, further comprising a secondary membrane module coupled to the fluid circuit, wherein the secondary membrane module is operable to separate the RO concentrate from the RO membrane module into a secondary permeate and a secondary retentate, the secondary permeate being received by the receiver tank.

18. The system according to claim 17, wherein the fluid circuit is configured to recover energy from the secondary retentate before discharging the secondary retentate.

19. The system according to claim 1, wherein the RO membrane module comprises one or more RO membranes, and wherein at least one of the one or more RO membranes is characterized by a rejection rate of 80% sodium chloride rejection rate or above 80% sodium chloride rejection rate.

20. A method comprising:
directing a feed along a first feed flow path in a fluid circuit, the fluid circuit being configured to provide a flow path in a system including a first tank and a reverse osmosis (RO) membrane module, the RO membrane module having an inlet, a permeate outlet, and a concentrate outlet, the RO membrane module being operable to separate the feed into a RO permeate and a RO concentrate;
directing the RO concentrate along a first concentrate flow path from the concentrate outlet to the first tank; and
directing the feed along a second feed flow path from the first tank to the inlet, wherein the first feed flow path and the second feed flow path are configured to receive the feed from different sources, and wherein the flow path includes the first feed flow path, the first concentrate flow path, and the second feed flow path; and
alternating between providing the first feed flow path in a first cycle and providing the second feed flow path in a second cycle, the first cycle and the second cycle being successive cycles of at least two cycles of liquid through the RO membrane module,
the first cycle including receiving the feed from a second tank and directing the feed along the first feed flow path to the RO membrane module with the second tank serving as a feed tank in the first cycle,
the first cycle including directing the RO concentrate along the first concentrate flow path from the RO membrane module to the first tank with the first tank serving as a receiver tank in the first cycle,
the second cycle including receiving the feed from the first tank and directing the feed along the second flow path from the first tank to the RO membrane module with the first tank serving as the feed tank in the second cycle.
the second cycle including directing the RO concentrate along a second concentrate flow path from the RO membrane module to the second tank with the second tank serving as the receiver tank.

21.-27. (canceled)
